(19) United States
(12) Patent Application Publication
(10) Pub. No.: US 2006/0265122 A1
(43) Pub. Date: Nov. 23, 2006

(54) METHOD FOR PLANNING ROUTE ACCORDING TO USER'S HABITS

(76) Inventors: Chien-Yang Chang, Taoyuan County (TW); Shu-Ling Chen, Yilan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,803

(22) Filed: May 9, 2006

(30) Foreign Application Priority Data
May 18, 2005 (TW) 94116047

(51) Int. Cl. G01C 21/30

(52) U.S. Cl. 701/209; 707/201

(57) ABSTRACT

A method for planning a route according to user's habits is disclosed. First, an electronic map is provided by a navigation device. The electronic map includes a plurality of virtual paths, wherein each virtual path has its own corresponding weight. Next, when the navigation device shows that the user is located in one of the plurality of virtual paths, the weight corresponding to this virtual path is added by a weighted value. Then, when planning the next route, the navigation device plans the route according to the newest weight of each virtual path to make the planned route be close to the user's habits.

### CROSS-REFERENCE TO RELATED APPLICATION

This application claims the priority benefit of Taiwan application serial no. 94116047, filed on May 18, 2005. All disclosure of the Taiwan application is incorporated herein by reference.

### BACKGROUND OF THE INVENTION

1. Field of Invention

The present invention relates to a method for planning a route, and more particularly, to a method for planning a route according to a user's habits.

2. Description of Related Art

Information changes significantly as time passes by; and modern people benefit a lot from various mobile devices for processing data and sending messages. The current mobile device with Global Positioning System (GPS) can receive satellite positioning signals.

Currently, GPS has been widely used in the commercial market. With the progress of satellite science and technology, many GPS technologies and business opportunities have appeared. In the early days, GPS was limited to military units, and aimed at military uses, e.g., precise positioning of fighters, military vessels, vehicles, personnel, and attack targets. Today, GPS has been open to public for positioning purposes. This technology combining the space satellite with communication technology has been developed vigorously in the civil market. For example, a moving vehicle can use GPS to determine the exact time and path to reach a destination; an ambulance can provide with emergency medical care more effectively; the driver of a vehicle can obtain the current position and destination through an electronic map provided by a navigation device.

As for the current mobile device with GPS functions (a navigation device), the navigation software, the GPS satellite navigation positioning technology, and the Geography Information System (GIS) are used together, such that the information of current position is displayed on the screen as direction guidance during navigation, thereby making it easy to reach the destination.

At present, many different types of navigation software are available in the market. Different developers of navigation software employ different algorithms to calculate the best route or the shortest route. However, the route obtained after calculation is not necessarily in accordance with the driving habits of a user. Taking an embodiment as an example, referring to FIG. 1, it is a schematic view of a plurality of virtual paths according to a preferred embodiment of the present invention. In FIG. 1, the virtual paths between each node (e.g., A2, A3, B2, B3, C2, C3 . . . ) have corresponding weights 4, 3, 3, 2, 4, 1 . . . . The path with higher weight may be the route to be planned first, for example, the route is planned according to the following sequence: highways are first, next are provincial highways, then common roads, and then alleyways, etc. In FIG. 1, there are six virtual connection routes between the starting point 110 and the end point 120, and the plurality of virtual paths for the six virtual connection routes is:

Virtual connection route 1: D4, D3, D2, A2, A3, F1

Virtual connection route 2: D4, D3, B2, E2, A3, F1

Virtual connection route 3: D4, D3, B2, B3, F2, F1

Virtual connection route 4: D4, C2, E3, E2, A3, F1

Virtual connection route 5: D4, C2, C3, F3, F2, F1

Virtual connection route 6: D4, C2, E3, B3, F2, F1

Then, the weights of all paths that may be passed are calculated, so as to obtain the total weight corresponding to each virtual connection route.

The total weight of the virtual connection route 1 is W(D4)+W(D3)+W(D2)+W(A2)+W(A3)+W(F1)=2+2+6+4+3+4=21.

The total weight of the virtual connection route 2 is W(D4)+W(D3)+W(B2)+W(E2)+W(A3)+W(F1)=2+2+3+1+3+4=15.

The total weight of the virtual connection route 3 is W(D4)+W(D3)+W(B2)+W(B3)+W(F2)+W(F1)=2+2+3+2+5+4=18.

The total weight of the virtual connection route 4 is W(D4)+W(C2)+W(E3)+W(E2)+W(A3)+W(F1)=2+4+1+1+3+4=15.

The total weight of the virtual connection route 5 is W(D4)+W(C2)+W(C3)+W(F3)+W(F2)+W(F1)=2+4+1+3+5+4=19.

The total weight of the virtual connection route 6 is W(D4)+W(C2)+W(E3)+W(B3)+W(F2)+W(F1)=2+4+1+2+5+4=18.

Then, the navigation software suggests that the virtual connection route 1 with higher total weight is planned first. However, the route may not be the one compliant with the user's habits. For instance, during rush hour, in order to avoid traffic jams, the user usually chooses a route with less traffic lights (e.g., the actual route corresponding to the virtual connection route 5) as his/her driving route. In this way, it can be seen that if the navigation software sums up the weights, make calculations, and plans the best route according to the original weights only, the best route may not comply with the user's habits. Therefore, the route suggested by the navigation software will not be adopted by the user.

### SUMMARY OF THE INVENTION

An object of the present invention is to provide a method for planning a path according to a user's habits. By adding a weighted value to the weight of the virtual path corresponding to the actual path, the more frequency the user passes this actual path, the higher the weight of the corresponding virtual path is, and thus, the planned route is closer to the user's habits.

The present invention provides a method for planning a route according to a user's habits, which is suitable for a navigation device. First, an electronic map is provided on the navigation device. The electronic map includes a plurality of virtual paths corresponding to the plurality of actual paths in a default district around the position of the navigation device, and each of the virtual paths has a corresponding weight. Next, when the user with the navigation device passes through a part of the actual paths, a weighted value is added to the weight of the virtual path corresponding to the passed actual path, thus the newest weight is generated. Then, whether a user employs the navigation device to plan the route or not is determined. When it is determined that the user employs the navigation device to plan the route, the route is planned according to the newest weight of each virtual path.

According to the preferred embodiment of the present invention, the step of planning the route according to the newest weight involves: first, obtaining a position of a starting point; next, a position of an end point is obtained; then, a plurality of virtual connection routes between the starting point and the end point are planned, and each of the virtual connection routes includes a part of the virtual paths; then, the weights of all the virtual paths in each of the virtual connection routes are added together, so as to obtain the total weight corresponding to each of the virtual connection routes; then, the total weight of each of the virtual connection routes is compared; and then, a plurality of virtual connection routes corresponding with the maximum total weights is displayed on the navigation device.

A weighted value is added to the weight of the virtual path corresponding to the actual path traveled by the navigation device in the present invention, such that the newest weight is generated to serve as the reference for planning routes. Therefore, the more frequency the user travels through the actual path, the higher the newest weight of the corresponding virtual path is, and the planned route is closer to the user's habits.

In order to make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a plurality of virtual paths according to a preferred embodiment of the present invention.

FIG. 2 is a flow chart of the method for planning a route according to a user's habits in a preferred embodiment of the present invention.

FIG. 3 is a flow chart of Step S240 in FIG. 2 of the method for planning the route according to a preferred embodiment of the present invention.

### DESCRIPTION OF EMBODIMENTS

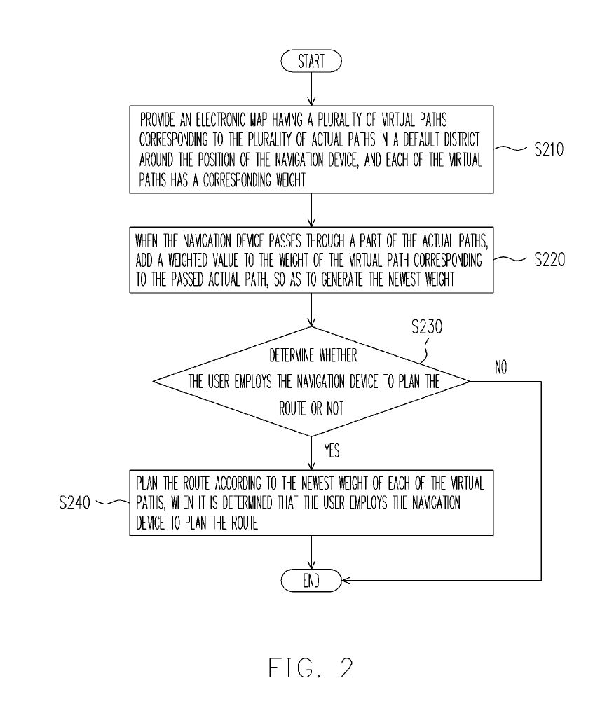

Referring to FIG. 2, it is a flow chart of a method for planning a route according to a user's habits in a preferred embodiment of the present invention. The method is suitable for a navigation device. The navigation device is, for example, a mobile device with GPS functions and can be operated together with navigation software for navigation. It will be apparent to those skilled in the art that the mobile device can be a notebook, smart phone, personal digital assistant (PDA), pocket PC, or mobile phone, but it is not limited to these herein.

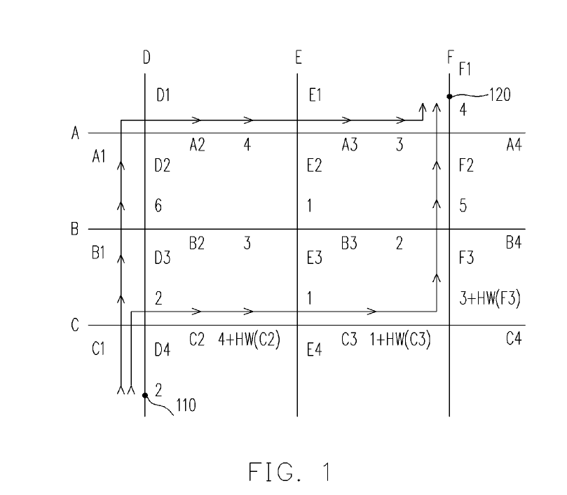

Referring to FIG. 2, in the method provided by the present invention, first, an electronic map is provided on the navigation device. The electronic map includes a plurality of virtual paths corresponding to the plurality of actual paths in a default district around the position of the navigation device, and each of the virtual paths has a corresponding weight (Step S210). Referring to FIG. 1, it is a schematic view of a plurality of virtual paths according to a preferred embodiment of the present invention. Together with reference to FIG. 2, the virtual paths between each node in FIG. 1 (e.g., A2, A3, B2, B3, C2, C3 . . . ) have corresponding weights 4, 3, 3, 2, 4, 1 . . . . The default district mentioned above is the scope of the virtual paths displayed on the screen of the navigation device.

It is assumed that the user with the navigation device passes through a part of the actual paths, a weighted value is added to the weight of the virtual path corresponding to the passed actual path, thus the newest weight is generated (Step S220). Taking an embodiment as an example, when the user with the navigation device passes through the actual paths corresponding to the virtual paths C2, C3, F3, a weighted value is added to the original weight of the virtual paths C2, C3, F3. The weighted value can be indicated by HW(Xn). In this embodiment, the weighted value is set to 1. In FIG. 1, the original weight of the virtual path C2 is 4, which is indicated by the mathematical expression W(C2)=4. When the user with the navigation device passes through the virtual path C2 in the present invention, a weighted value is added to the original weight of the virtual path C2, so as to generate the newest weight, which is indicated by the mathematical expression W(C2)+HW(C2), wherein W(C2) is 4 and HW(C2) is 1. Therefore, the newest weight value W(C2) of the virtual path C2 is 5.

According to the above embodiment, it is assumed that the user with the navigation device passes through the virtual path C2 again, a weighted value is added to the weight of the corresponding virtual path according to Step S210, thus the weight W(C2) is increased to 6 from the previous 5. If the final newest weight W(C2) of C2 is 8, it indicates that the user with the navigation device passes through the C2 path for four times in total.

Next, the navigation device determines whether the user employs the device to plan the route or not (Step S230). When it is determined that the navigation device is not employed to plan routes, the step jumps to the end, i.e., the flow of planning the route is completed. When it is determined that the navigation device is employed to plan routes, a route is planned according to the newest weight of each virtual path (Step S240). For example, if the virtual path C2 is needed when planning the route, the newest weight value W(C2) is used to plan the guidance route. How to plan the guidance route is illustrated below in detail.

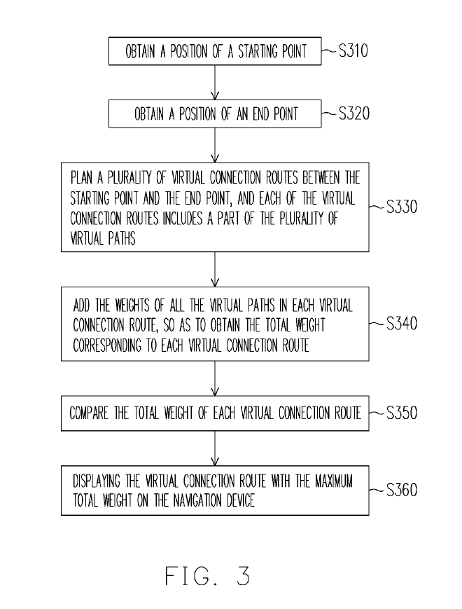

Referring to FIG. 3, it is a flow chart of Step S240 in FIG. 2 of the method for planning the guidance route according to a preferred embodiment of the present invention, which is illustrated together with FIG. 1. First, a position of the starting point is obtained by the navigation device (Step S310), e.g., 110 in FIG. 1. In the preferred embodiment of the present invention, it is apparent to those skilled in the art that the starting point 110 mentioned in this embodiment may be the position of the navigation device or the position set by the user.

Next, a position of the end point is obtained by the navigation device (Step S320), e.g., 120 in FIG. 1. The position of the end point 120 may be the position set by the user.

Then, the navigation device plans a plurality of virtual connection routes between the starting point 110 and the end point 120. Each virtual connection route includes a part of the plurality of virtual paths (Step S330). For example, there are six virtual connection routes between the starting point 110 and the end point 120 in FIG. 1. The plurality of virtual paths for the six virtual connection routes are:

Virtual connection route 1: D4, D3, D2, A2, A3, F1

Virtual connection route 2: D4, D3, B2, E2, A3, F1

Virtual connection route 3: D4, D3, B2, B3, F2, F1

Virtual connection route 4: D4, C2, E3, E2, A3, F1

Virtual connection route 5: D4, C2, C3, F3, F2, F1

Virtual connection route 6: D4, C2, E3, B3, F2, F1

Then, the navigation device adds the weights of all the virtual paths in each virtual connection route, so as to obtain the total weight corresponding to each virtual connection route (Step S340). It should be considered that the virtual paths C2, C3, and F3 in FIG. 1 have the weighted values 4, 5, and 4.

The total weight of the virtual connection route 1 is W(D4)+W(D3)+W(D2)+W(A2)+W(A3)+W(F1)=2+2+6+4+3+4=21.

The total weight of the virtual connection route 2 is W(D4)+W(D3)+W(B2)+W(E2)+W(A3)+W(F1)=2+2+3+1+3+4=15.

The total weight of the virtual connection route 3 is W(D4)+W(D3)+W(B2)+W(B3)+W(F2)+W(F1)=2+2+3+2+5+4=18.

The total weight of the virtual connection route 4 is W(D4)+W(C2)+HW(C2)+W(E3)+W(E2)+W(A3)+W(F1)=2+4+4+1+1+3+4=19.

The total weight of the virtual connection route 5 is W(D4)+W(C2)+HW(C2)+W(C3)+HW(C3)+W(F3)+HW(F3)+W(F2)+W(F1)=2+4+4+1+5+3+4+5+4=28.

The total weight of the virtual connection route 6 is W(D4)+W(C2)+HW(C2)+W(E3)+W(B3)+W(F2)+W(F1)=2+4+4+1+2+5+4=22.

Finally, a plurality of virtual connection routes with the maximum total weights is displayed on the navigation device (Step S360). That is, the virtual connection route 5 is determined as the planned route and displayed on the screen.

In the preferred embodiment of the present invention, as for the weighted value mentioned in the above embodiment, it is apparent to those skilled in the art that the weight value of each virtual path has a limit. If the limit is exceeded, the calculation principle of the original navigation software is influenced.

To sum up, as for the method for planning a path according to a user's habits of the present invention, a weighted value is added to the weight of the virtual path corresponding to the passed actual path, and the generated newest weight serves as a reference for planning routes. Therefore, the more frequency the user passes the actual path, the higher the newest weight of the corresponding virtual path is, and the planned route is closer to the user's habits.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for planning a route according to a user's habits, suitable for a navigation device, comprising:
providing an electronic map having a plurality of virtual paths corresponding to the plurality of actual paths in a default district around the position of the navigation device, wherein each of the virtual paths has a corresponding weight;
when the navigation device passes through at least a part of the actual paths, adding a weighted value to the weight of the virtual path corresponding to the passed actual path, so as to generate a newest weight;
determining whether a user employs the navigation device to plan the route or not; and
planning the route according to the newest weight of each of the virtual paths when it is determined that the user employs the navigation device to plan the route.

2. The method for planning a route according to a user's habits as claimed in claim 1, wherein the step of planning the route according to the newest weight of each of the virtual paths comprises:
obtaining a position of a starting point;
obtaining a position of an end point;
planning a plurality of virtual connection routes between the starting point and the end point, wherein each of the virtual connection routes includes a part of the virtual paths;
adding the weights of all the virtual paths in each of the virtual connection routes, so as to obtain the total weight corresponding to each of the virtual connection routes;
comparing the total weight of each of the virtual connection routes; and
displaying the virtual connection routes with the maximum total weights on the navigation device.

3. The method for planning a route according to a user's habits as claimed in claim 2, wherein the starting point is the position of the navigation device.

4. The method for planning a route according to a user's habits as claimed in claim 2, wherein the starting point is set by the user.

5. The method for planning a route according to a user's habits as claimed in claim 2, wherein the end point is set by the user.

6. The method for planning a route according to a user's habits as claimed in claim 1, wherein the navigation device is a mobile device with Global Positioning System (GPS) functionality.
